(19) United States
(12) Patent Application Publication
(10) Pub. No.: US 2007/0240209 A1
(43) Pub. Date: Oct. 11, 2007

(54) Session persistence on a wireless network

(76) Inventors: Adam C. Lewis, Buffalo Grove, IL (US); Christophe Beaujean, Arpajon (FR); Zurabl Khukhashvili, Kiryat ono (IL)

Correspondence Address: MOTOROLA, INC., 1303 EAST ALGONQUIN ROAD, IL01/3RD, SCHAUMBURG, IL, 60196, US

(21) Appl. No.: 11/398,975

(22) Filed: Apr. 5, 2006

(51) Int. Cl. G06F 15/16

(52) U.S. Cl. 726/15

(57) ABSTRACT

The present disclosure provides methods and systems for preventing the termination of a communication session between two devices, where the communication session is being conducted over a wireless network, at least in part. More specifically, the present disclosure provides methods and systems for the prevention of a TCP session's premature termination, or TCP session persistence, in such a network by simulating signals of normal communication so that the receiving device “believes” that the simulated signals have been transmitted from the other device. Simulated signals, sent from a session persistence driver, are only sent to a device when expected signals which are expected to be received by that device are not detected.

### FIELD OF THE INVENTION

This invention relates to session persistence. More specifically, the invention relates to methods and systems for session persistence on a wireless communications network.

### BACKGROUND

Increases in the number of mobile computing devices, such as wireless computing devices, coupled with increasing prevalence of corporate enterprise networks has resulted in the need for reliable, transparent access to network-oriented applications from wireless computing devices.

Enterprise networks include enterprise applications, typically running on enterprise servers. These enterprise applications contain business logic which performs functions such as accounting, production scheduling, customer information tracking, and account maintenance. The growing demand for access to enterprise networks, as well as other corporate computer networks providing services to a large number of users, has spurred the development of virtual private networks (“VPNs”).

A VPN is a private communications network typically used within a company to communicate over a public network. VPN message traffic is carried on public networking infrastructure using standard protocols. Often VPNs use cryptographic tunneling protocols to provide the necessary confidentiality, sender authentication, and message integrity to achieve the necessary privacy. The use of a VPN can extend geographic connectivity, improve security, reduce operational costs from a traditional Wide Area Network (“WAN”), provide telecommuter support, and show a good economy of scale.

Improvements in mobile computing have occurred simultaneously with the networking advancements described above. One such development is Mobile IP. Mobile IP is an Internet Engineering Task Force (“IETF”) standard communications protocol that is designed to allow mobile device users to move from one network to another while maintaining their permanent IP address.

Networking methods have evolved to allow robust communications over unreliable traditional wired data networks. To a large extent, increased reliability over such traditionally unreliable networks has been accomplished by the development of connection-oriented, end-to-end reliable protocols, such as the Transmission Control Protocol (TCP), as specified in the IETF RFC 793. TCP has been designed to perform end-to-end data transmission reliably by communicating in a session. TCP guarantees reliable and in-order delivery of sender-to-receiver data. TCP also distinguishes data for multiple, concurrent applications running on the same host. Many off-the-shelf networking applications have been developed to interface with TCP, because the TCP engine is a successful and widely used transport protocol engine. As a connection-oriented protocol, TCP requires periodic indications of the connection state, such as, for example, the reception of acknowledgement (“ACK”) transmissions. Without these indications, the session is terminated. Transport protocols such as TCP are optimized for wired data communications networks and greatly increase the reliability of data transmission over such a network.

Networking applications, such as networking applications that utilize VPN and Mobile IP functionality, have been developed to utilize the reliability of the connection-oriented TCP to the extent that, often, these networking applications require the use of TCP sessions to fully realize the benefits of the application. When grafted to wireless technology, however, such networking applications suffer performance decreases. Wireless networks are characterized by extended periods of “intermittent connection” caused by long handover delays or temporary disconnection from a Radio Area Network (“RAN”). In wireless technology, therefore, sessions are often prematurely terminated due to the temporary interruptions in communications inherent in wireless networking which prevent periodic indications of the connection state from being received. Thus, a problem is a way to keep communications going despite a lack of connection, an issue referred to as TCP session persistence.

Many off-the-shelf networking applications, for example, require TCP/IP sessions or private virtual circuits. Some applications deal extremely poorly with the loss of a TCP connection, sometimes even requiring a total reboot of the machine. Hence, a means is required to keep a TCP connection alive when the participants experience extended periods of disconnection. These problems have been addressed by the development of new technology.

For example, U.S. Pat. No. 5,566,225 by Hass et al. (“the '225 patent”), the complete subject matter of which is hereby incorporated by reference, discloses a system for maintaining a TCP session over a wireless network between a mobile end-user device and a host. The system for TCP session persistence disclosed in the '225 patent uses a “Local Agent” executed in the mobile end-user device and a “Network Agent” executed in a processor in the wireless network or in the host to simulate the operative mode of the TCP session upon detecting an inoperative condition of a wireless link. The '225 patent, however, does not address the integration of TCP persistence into server-proxied communications networks.

U.S. Pat. No. 6,546,425 by Hanson et al. (“the '425 patent”), the complete subject matter of which is hereby incorporated by reference, discloses TCP session persistence on a proxied Mobility Management Server (“mobility server”) network. For example, the '425 patent discloses a mobility server providing user configurable session priorities for “Mobile End Systems” (i.e., mobile clients), per-user mobile policy management for managing consumption of network resources, and address management for the mobile clients.

FIG. 1 is an illustrative implementation of the '425 patent. In the illustrated system, the mobility server 120 maintains the state of each of the mobile clients 102 and handles the complex session management required to maintain persistent connections to the network and to other processes, such as processes running on a host system 138. If a mobile client 102 becomes unreachable, suspends, or changes network address, the mobility server 120 maintains the connection to the host system 138 by acknowledging receipt of data and queuing requests above the UDP engine 128 and the TCP engine 130 in the protocol stack, as is explained further below. This proxying by the mobility server 120 allows the Network Application 104 on the mobile client 102 to maintain a continuous connection even though it may temporarily lose its wireless connection 136. The mobility server 120 also manages addresses for mobile clients 102, and in this regard each mobile client 102 is provided with a proxy address on the primary network, known as the “virtual address” of the mobile client 102. The mobility server 120 maps the virtual addresses, which remain constant, to current “point of presence” addresses of the mobile clients 102 as the mobile system changes from one network interconnect to another.

In the '425 patent, TCP session persistence is implemented above the transport protocol engine (e.g., the TCP engine) through a Transport Driver Interface (“TDI”) 108 utilizing a Mobile Interceptor 110. The Mobile Interceptor 110 intercepts certain calls at the TDI 108 interface and routes them via remote procedure calls (“RPC”) and Internet Mobility Protocols to the mobility server 120 over the network using the standard transport protocols. Such standard transport protocols can include TCP as provided by a TCP engine 114, and the User Datagram Protocol (“UDP”), a connectionless protocol provided by a UDP engine 112. A remote procedure call is a type of protocol that allows a program on one computer to execute a program on a server computer. Mobile Interceptor 110 thus can intercept all network activity and relay it to the mobility server 120 using RPC operations rather than TCP operations. The Mobile Interceptor 110 works transparently with operating system features to allow client-side application sessions to remain active when the mobile client 102 loses contact with the network. The mobility server 120 effectively operates as the mirror image, working with the host system 138 in a manner similar to the operating system on the mobile client 102. Thus the separate RPC operations replace the TCP operations for the RAN.

Although the '425 patent discloses a means of persistent proxied networking, its implementation of the persistence means above the TCP engine is unwieldy. In one implementation currently available in the marketplace, for example, this architecture enables session persistence by hooking the socket application program interface (“API”), a set of routines, protocols, and tools for connecting an application to a network protocol, to redirect TCP application calls from off-the-shelf applications to a specifically engineered TDI 108. The socket application program interface is implemented in the system of FIG. 1 as Windows Sockets (“Winsock”) 1.1/2.0 106, an API that allows Windows network software to access network services such as TCP. The TDI 108 terminates the TCP call and opens a UDP socket to the server. Hooking a socket API to redirect an application's TCP calls to a proprietary driver is relatively untested, often problematic, and requires extensive configuring. The TDI 108 must re-implement the TCP behavior that TCP-oriented applications expect, such as acknowledgement generation, acknowledgement timeout, duplicate detection, and segment reordering. Such extensive implementation, furthermore, often limits the number of applications available to be used by the Mobility Management Server 120.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 illustrates a TCP persistence over a network according to the prior art;

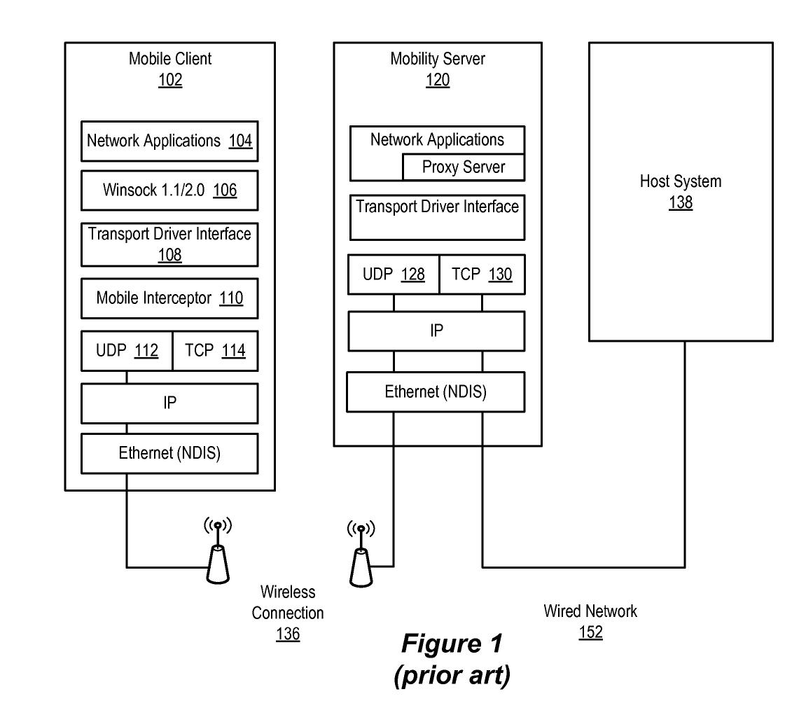

FIG. 2 illustrates a system for TCP session persistence between a host system and a client on a mobile computing device over a server-proxied network according to embodiments of the present invention;

FIG. 3 is a data flow diagram illustrating a method for TCP session persistence between a host system and a client on a mobile computing device over a server-proxied network according to embodiments of the present invention;

FIG. 4 illustrates the transfer of information between layers of the International Standards Organization Open Systems Interconnection (“ISO/OSI”) network protocol model;

FIG. 5 is a data transmission diagram illustrating TCP persistence on the mobile client side of a wireless connection according to embodiments of the present invention; and

FIGS. 6A and 6B are data transmission diagrams illustrating TCP session persistence according to embodiments of the present invention on the mobility server/host side of a wireless connection upon an interruption in the wireless connection.

### DETAILED DESCRIPTION

The present disclosure prevents the termination of a communication session between two devices (entities), where the communication session is being conducted, at least in part, over a wireless network, and a temporary interruption in the communication occurs. For ease of explanation, it should be noted that the following description and examples specifically refer to TCP, however, any other connection-oriented transport protocols may be used (e.g., a stream control transmission protocol). Thus, more specifically in one embodiment, the present disclosure prevents premature termination of a TCP session when a temporary interruption occurs in the communication, through session persistence by having a first device generate a standard TCP signal such that the first device “believes” that the generated signals were transmitted from the second device in the session and that the session is still “alive”. These signals are only generated when an interruption in network communications is detected. An interruption in network communications may be detected by identifying when signals which are expected to be received by a device are not detected. In TCP session persistence, these expected signals may be acknowledgement signals. Acknowledgement signals are control packets sent by the transport layer of the first device engaged in the TCP session to the transport layer of the second device engaged in the TCP session to acknowledge the receipt of a transmission from the second device. Thus, upon receiving the signals, the second device “believes” that the first device is still in communication with the second device and that the TCP session between them should not be terminated.

Significantly, and in contradistinction from the prior art as discussed in the Background of this disclosure, the session persistence driver is located below the TCP layer on both the first and the second devices (and a server is not needed) or below the TCP layer on the server and the first device (if the second device cannot be modified with the present invention), so as to simulate signals without interrupting the standard interface between application-level programs and the transport layer on the first device, the second device, and the server (if present). In other words, the session persistence driver simulates signals at an ISO/OSI network protocol model layer below the transport layer, as will be described in further detail below. This configuration allows the full utilization of the TCP layer by the application through the standard interface.

For example, TCP session persistence may be implemented, in some embodiments, by simulating to the TCP layer of the second device acknowledgement signals from the TCP layer of the first device. TCP session persistence may also be implemented by simulating to the TCP layer of the first device acknowledgement signals from the TCP layer of the second device. In one implementation, acknowledgement signals from each device are simulated to the other device. By placing the session persistence driver below the TCP layer, applications may utilize TCP calls to initiate network communications. Because many, if not most, off-the-shelf applications are designed to use TCP as the transport layer protocol for networking, interfacing these applications to a TCP layer is configured easily and results in reliable communication networks, due to extensive testing of these configurations. In addition, changes and upgrades in application software are seamless because the application layer and transport layer are each self-contained.

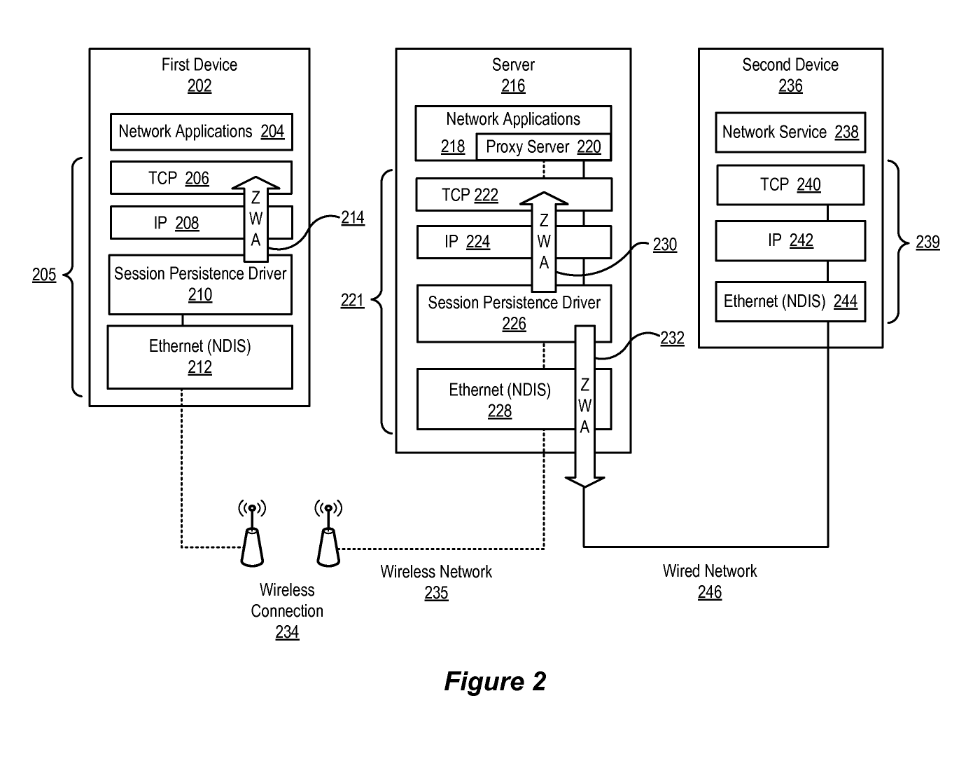

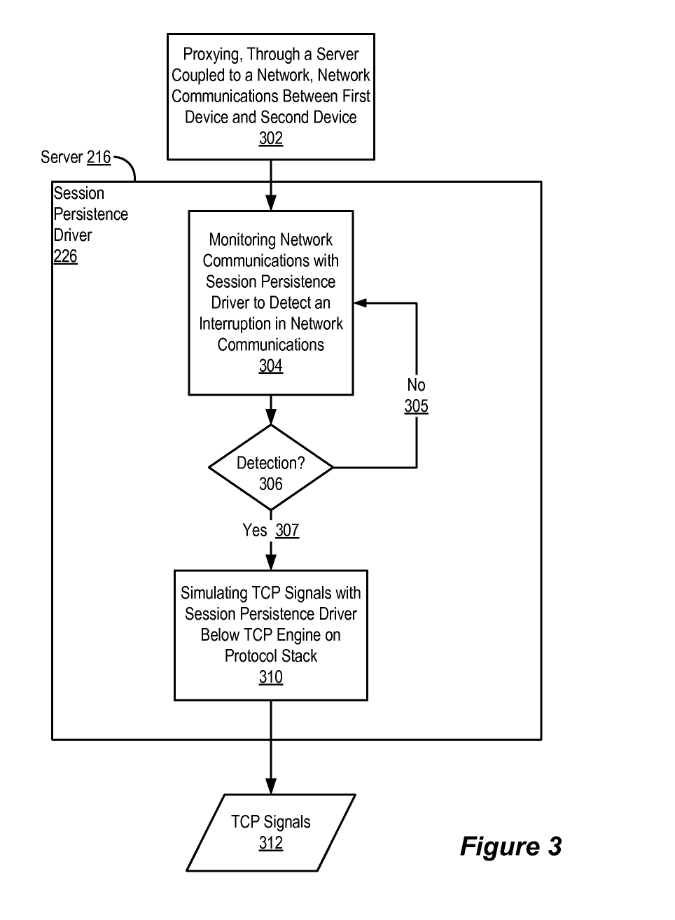

FIG. 2 illustrates a system for TCP session persistence between a first device 202 and a second device 236 over a server-proxied network. The term “server-proxied network” denotes a network whereupon communications between the first device 202 and the second device 236 are proxied by a server 216 having a proxy server 220 application installed and running on it. The server-proxied network of FIG. 2 is implemented by connecting the second device 236 to the server 216 though a wired network 246 and connecting the first device 202 to the server 216 through a wireless network 235 having a wireless connection 234. Such proxying is explained further below with respect to FIG. 3. Although the present disclosure references a server proxying communications between a first device 202 on a wireless network and a second device on a wired network, other implementations of the present invention may include a server proxying communications between two devices, each of which are on a wireless network or two wireless devices incorporating the present invention, thus eliminating the need for the server completely.

The first device 202, the server 216, and the second device 236 are each implemented to some extent as software modules installed and running on a computer, that is, an automated computing device, with each including at least one processor or “CPU” (not shown) as well as a computer memory (not shown), including both volatile random access memory (“RAM”) and some form or forms of non-volatile computer memory such as a hard disk drive, an optical disk drive, or an electrically erasable programmable read-only memory space (also known as ‘EEPROM’ or ‘Flash’ memory). The computer memory is connected through a bus to the processor and to other components of the computer. Thus, the software modules are program instructions stored in a computer memory.

The second device 236 comprises software installed and running on a computer, including one or more network services 238 which perform tasks or access information. In an enterprise networking model, the second device 236 may include business logic for performing a company's business operations and applications for accessing a company's confidential information.

The proxy server 220, one of several network applications 218 which run in the ISO/OSI application layer in the server 216 but could run in kernel space, allows the first device 202 to indirectly connect to or access other network services 238 on the second device 236 via the server 216. The server 216 also enables additional functionality to be added to the network as is discussed below. Thus, in one embodiment, although in normal operation the first device 202 and the second device 236 seemingly communicate with each other transparently, communications are actually implemented between the first device 202 and the second device 236 through a first TCP session between the first device 202 and the server 216 and a second TCP session between the server 216 and the second device 236. These TCP sessions include transmissions made up of requests for data, responses to those requests, and signals for the operation of the session. A TCP session appears to be initiated between the first device 202 and the second device 236 by those devices, but the session is actually intercepted by the server 216, and split into the two TCP sessions described above. Alternatively, only one TCP session may be used between the first device and the second device.

The first device 202 connects to the network services 238, therefore, by initiating a TCP session with the proxy server 220 as described above and then requesting a connection, file, or other resource available on the second device 236. The proxy server 220, once connected to the specified second device 236, provides the resource by obtaining the resource from the second device 236 or by serving the resource from a designated location in memory.

Each of the server 216, the first device 202, and the second device 236 include application software components (network applications 218, network applications 204, and network services 238, respectively) operating at the application layer of the ISO/OSI network protocol model which perform high-level operations involving communication between software applications and lower-layer network services so that the network can interpret an application's request and the application can interpret data sent from the network.

Each of the server 216, the first device 202, and the second device 236 of FIG. 2 also includes a TCP layer (206, 222, and 240), an IP layer (208, 224, and 242), and a Network Driver Interface Specification (“NDIS”) application programming interface (“API”) (212, 228, and 244) forming portions of a network communications stack (205, 221, and 239) to facilitate network communications. Application software components (network applications 218, network applications 204, and network services 238) make TCP application calls to their respective TCP layers (206, 222, 240) to transmit information to other application software components over the network. Typically, information is transmitted from the application software component to the TCP layer in a continuous byte stream.

TCP layers 206, 222, and 240 implement TCP which, as described above, uses error checking to insure reliable and in-order delivery of data packets to the appropriate application running on the receiving computer. The IP layers 208, 224, and 242 running in each entity implement the IP layer which insures delivery of the data packets by addressing the packet with a machine-unique IP address. The NDIS API (212, 228, and 244) is a network card interface providing the functional and procedural means to transfer data between network entities through the computer's network card and the Ethernet to the corresponding entity's network card. The NDIS API addresses data packets by using a physical addressing scheme, such as a Media Access Control (“MAC”) address which is hard-coded into most networking equipment at the time of manufacture. Although the server 216, the first device 202, and the second device 236 of embodiments disclosed in FIG. 2 each include an NDIS API as a network card interface, alternate embodiments of the system of FIG. 2 may include the use of any network filter (e.g., Linux) and still be well within the scope of the invention as defined in the claims.

As is significant to embodiments of the invention, the server 216 is coupled to the network through one or more session persistence drivers 226 in the network communications stack 221. The session persistence driver(s) 226 of FIG. 2 is a software module that monitors network communications to detect an interruption, and to create signals to maintain TCP persistence, as will be explained in further detail below. The session persistence driver 226 is coupled to the TCP layer 222 via the IP layer in the server 216. All communications below the TCP layer 222 pass through the session persistence driver 226, as will be explained in further detail later. The IP layer 224 is further coupled to the network through the NDIS API 228. The TCP/IP stack and the NDIS API 228 are discussed in further detail below. In some embodiments, the session persistence driver 226 is executed on a separate processor independent of the processor in the server 216. In other embodiments, the session persistence driver 226 may be implemented as hardware or a combination of hardware and software. All such embodiments are session persistence drivers 226 as intended as within the scope of present invention.

To perform its TCP session persistence function, session persistence driver 226 includes computer program instructions for generating one or more TCP signals adapted to be interpreted by the TCP layer 240 in the second device 236 as being transmitted from the first device 202. In one embodiment, session persistence driver 226 generates and sends a zero-window advertisements (“ZWA”) 230 up the protocol stack to the TCP layer 222 and ZWAs 232 down the protocol stack and through the wired network to the TCP layer 240 on the second device 236 so as to “convince” TCP layers 222 and 240 that the TCP layer 206 is still connected and maintain a TCP session between the first device 202 and the second device 236. Such simulated ZWAs 230 are generated below the transport layer from an ISO/OSI network protocol model perspective, commensurate with embodiments of the invention, as will be explained in further detail later.

The first device 202 also contains a session persistence driver 210, which likewise generates one or more TCP signals, in the network communications stack 205. The TCP signals of session persistence driver 210 are adapted to be interpreted by the TCP layer 206 in the first device 202 as being transmitted from the second device 236. Session persistence driver 210 is thus similarly enabled to generate and send ZWAs 214 up the protocol stack to the TCP layer 206 so as to “convince” the TCP layer 206 that the TCP layer 240 (or 222) is still connected, so as to maintain a TCP session between first device 202 and the second device 236.

With a basic description of the system in hand, attention now turns to FIG. 3, which sets forth a flow chart illustrating a method for maintaining TCP session persistence over a network according to an embodiment of the present invention. For consistency, the reference numerals of FIG. 2 are used throughout description of the flow chart of FIG. 3. The method starts by proxying network communications via a server 216 (step 302). As noted above, this may be carried out by utilizing a proxy server 220 in the server 216 to implement VPN and Mobile IP for the communications network as explained in the Background section of this disclosure.

The Mobile IP functionality implemented in the present method may include functions implemented by the specifications Mobile IPv4, Mobile IPv6, or any other Mobile IP specification known to those of skill in the art. In a preferred Mobile IP implementation, each wireless device (e.g., the first device 202) is always identified by its home address, regardless of its current point of attachment to the Internet. Additionally, while the first device 202 is located away from home, it is also associated with a “care-of” address, which provides information about its current point of attachment to the Internet, as is well known. In short, proxying step 302 can also provide for registering the care-of address and other basic networking particulars as would typically occur between a first device 202 and a second device 236.

As discussed above, a VPN is a private communications network typically used within a company to communicate over a public network. Often, VPNs use cryptographic tunneling protocols to provide the necessary confidentiality, sender authentication, and message integrity to achieve privacy. Accordingly, proxying step 302 can in some implementations include transmitting data using a cryptographic tunneling protocol, i.e., an encrypted network protocol which encapsulates one protocol or session inside another. In such a VPN implementation, the system may require all traffic to pass through the tunnel while the VPN is active to improve security over unsecured networks. Transmitting data using a cryptographic tunneling protocol may also include providing other VPN functionality, such as, for example, private addressing.

As described above, TCP session persistence according to the present disclosure includes using session persistence drivers 210, 226 to simulate expected TCP transmissions during a temporary disconnect. In performance of this task, and as shown in FIG. 3, the session persistence drivers 210 and 226 include computer program instructions for monitoring (304) network communications between the first device 202 and the second device 236; detecting (306) a temporary interruption in the network communications; and upon detection of a temporary interruption (307) preventing the transport layer from terminating the session during the temporary interruption (310), as explained in further detail below.

During the monitoring step (304), the session persistence drivers 210 and 226 in the first device 202 and the server 216, respectively, operate to detect an interruption in network communications. Because a TCP session continues as long as expected signals from one TCP layer are received by the other TCP layer, this monitoring step 304 can comprise transparently passing received TCP signals and detecting a failure to receive an expected TCP signal. In some implementations, TCP data packets are received in the session persistence drivers and then handed to the TCP layer. In alternate embodiments, the TCP data packets are only monitored until an interruption in communication is detected, at which time the session persistence driver enters an activated state and inserts itself into the stack to have all TCP data packets pass through the session persistence driver. One such signal useful for this monitoring purpose is an ACK” signal, which acknowledges receipt of a transmitted packet. Accordingly, during a session, when a first TCP layer sends a TCP packet to a second TCP layer, it awaits the return of an ACK signal. A timer of the sending TCP layer will cause a timeout if an acknowledgement is not received within a reasonable round-trip time, and the (presumably lost) data will then be re-transmitted. After a configurable amount of time, or a configurable number of retries, the sending TCP layer terminates the session. The session persistence drivers 210 and 226, in the first device 202 and the server 216 respectively, prevent this termination by responding to a detected temporary interruption in communication. For the session persistence driver, the temporary interruption in communication may also be detected as a configurable amount of time or a configurable number of retries without receiving an expected acknowledgement. The configurable amount of time and the configurable number of retries for the session persistence driver, however, are each less than that of the TCP layer, which allows the session persistence driver to prevent termination of the TCP session. The session persistence drivers 210, 226 may alternatively detect a temporary interruption in communication through an external indication. An external indication may be any external input from which the session persistence module should infer an interruption in communications, such as, for example, a hardware interrupt, a software event, or a policy change notification.

Once an interruption has been detected (step 306), the next step (310) in the method of FIG. 3 is to prevent the transport layer from terminating the session during the temporary interruption by, for example, simulating signals so that the system persists in keeping the first device 202 and the second device 236 linked, despite the temporary interruption. Thus, simulating TCP signals 312 is carried out using the session persistence driver(s) 210, 226, which simulate a continuous data communication session between the first device 202 and the second device 236 despite the temporary interruption.

As noted earlier, in embodiments of the invention, the session persistence drivers 210 and 226 are below the TCP layers 206 and 222, respectively, meaning that such simulation of signals occurs at ISO/OSI levels below that of the TCP layers 206 and 222, with the benefits that applications may utilize TCP calls to initiate network communications, increasing the reliability of the server-proxied network and making upgrading of the network easier.

In one embodiment, the simulation step (310) comprises generating, in one or

both session persistence drivers 210, 226 one or more TCP signals 312 adapted to be interpreted by the second device 236 as coming from the first device 202 or interpreted by the first device 202 as coming from the second device 236. The TCP signals 312 indicate that a buffer allocated to receive incoming data in the second device is full (e.g., ZWAs). In response to a ZWA signal, a TCP layer stops sending data packets, but still maintains the TCP session. Again, the ZWA signal is generated at a level in the ISO/OSI stack below the TCP layer.

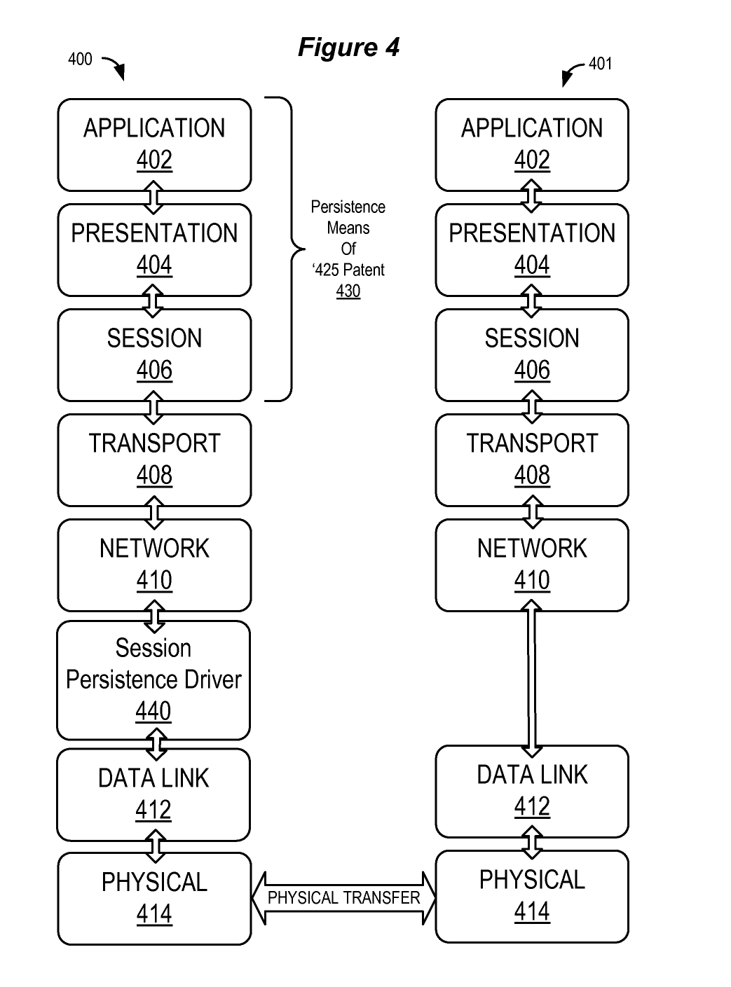

FIG. 4 illustrates the transfer of information between layers of the ISO/OSI network protocol model, which is a guide providing a framework for developing standards for networking services and protocols, in two different nodes 400 and 401. The protocol model has seven layers. From top to bottom, they are as follows: the application layer 402 (layer seven), the presentation layer 404 (layer six), the session layer 406 (layer five), the transport layer 408 (layer four), the network layer 410 (layer three), the data link layer 412 (layer two), and the physical layer 414 (layer one). Each layer uses the services of the layer below and provides a service to the layer above. A layer in one node 400 communicates with the equivalent layer in a different node 401. Data propagates from a protocol layer in a first device to the same protocol layer in a second device by handing data down to the next lowest layer, which in turn hands the data to the layer below it. Data is physically transferred to another node at layer 1, the physical layer. The data is then passed up from one layer to the next until reaching its destination. Each layer adds information in a header as it passes data down, and uses information by removing the header on the way up. Readers of skill in the art will recognize that no network is implemented exactly as the protocol model shows. In practice, layers five and six are often omitted. When describing a first layer as being below a second layer, we mean to say that the first layer is any layer that is numerically lower than the second layer. The session persistence driver 440 of the present invention is implemented below the transport layer 408. Hence, it resides at any layer lower than the fourth (transport) layer, such as, for example, the network layer 410, the data link layer 412, or a layer between them (e.g., what is known to those of skill in the art as layer 2.5). In contrast, the persistence means of the '425 patent 430, for example, operates above the transport layer 408. It should also be noted that even the present description refers to a “layer” performing a function for ease of explanation, it should be understood by one skilled in the art that protocols or devices within the layer may actually be performing the function. For example, the transport layer has a transport protocol that is implemented by a transport protocol engine or similar device.

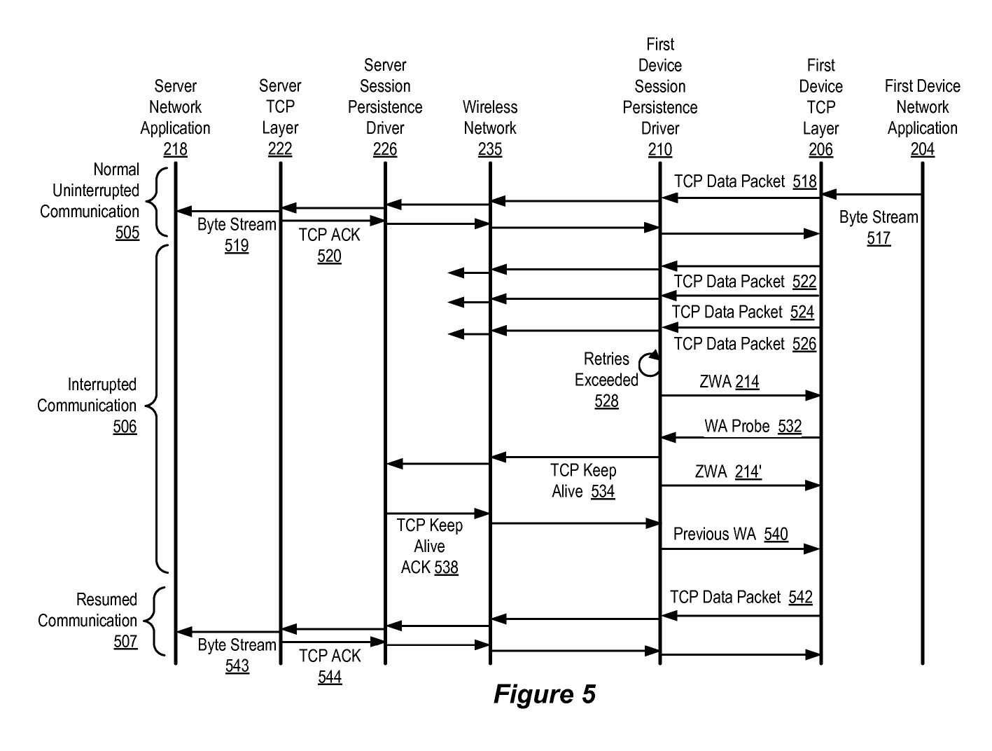

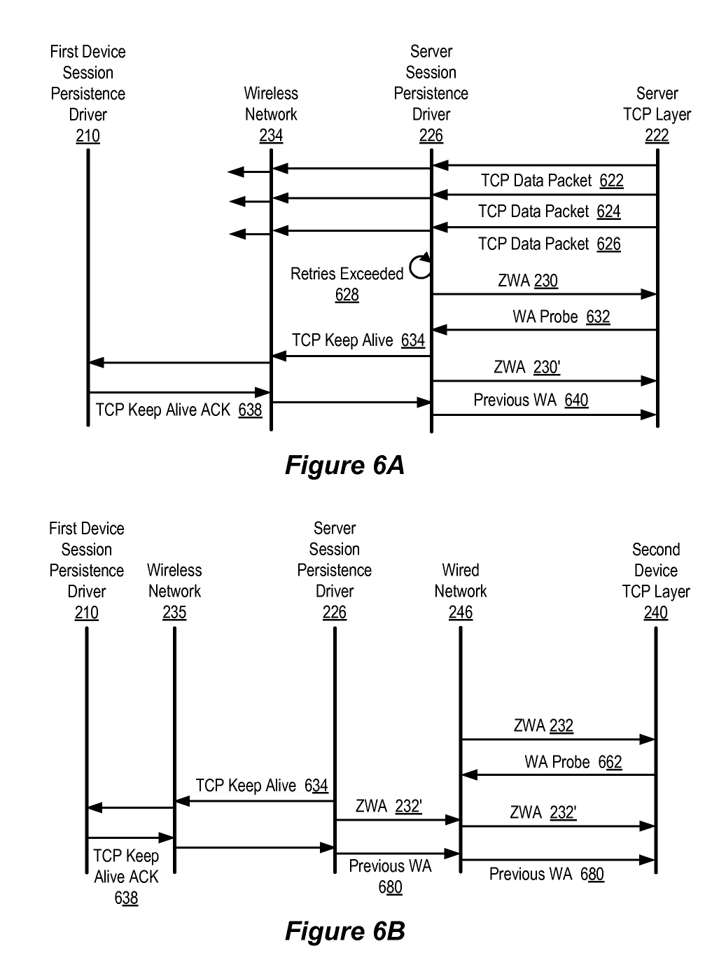

For further explanation of embodiments of the invention, FIG. 5 sets forth a call diagram illustrating the transmission of data over the network of FIG. 2 according to the method disclosed in FIG. 3. Because session persistence is triggered on both the first device on the wireless network and the second device on the wired network of FIG. 2, FIGS. 5, 6A, and 6B illustrate signal transmission on both of these sides. In each of the call diagrams, the transmission of data packets from one module to another is illustrated in a chronological sequence from the top to the bottom of the Figures.

FIG. 5, illustrating TCP session persistence on the first device 202 side of the wireless connection 234, first shows (505) the transmission of data packets in a TCP session when no interruption exists in the wireless connection 234 between the first device 202 and the server 216. As can be seen, in such as case, a byte stream flows from the first device application 204 to the server network application 218 through the various intermediaries illustrated in FIG. 2. Specifically, the first device application 204 sends a stream of 8-bit bytes, or byte stream 517, to the TCP layer 206 in the first device for delivery through the network. The TCP layer 206 in the first device stores the byte stream 517 in a buffer and begins constructing segments, or TCP data packets, containing the data from the byte stream 517, beginning with the first TCP data packet 518. Each packet is given a sequence number. The TCP layer 206 in the first device passes resulting TCP data packet 518 to the Internet Protocol layer 208 (not shown). In some embodiments, the TCP data packet 518 is sent from the Internet Protocol layer 208 (not shown) to the session persistence driver 210 for delivery from the session persistence driver 210 through the wireless network 235 to the session persistence driver 226 at the server 216. In alternate embodiments, the session persistence driver only monitors the data packet 518, which is sent from the Internet Protocol layer 208 (not shown) through the wireless network, until activated as described above. Both implementations are included in the following discussion referring to the session persistence driver 210, 226 passing data packets. The session persistence driver 226 passes the data packets to TCP layer 222 in the server which checks to make sure that no data packets are lost and that the data packets are in correct order by analyzing the sequence number on each packet. The TCP layer 222 in the server delivers the information in byte stream 519 to the network applications 218. The TCP layer 222 in the server sends back an acknowledgement, TCP ACK 520, for the successfully received TCP data packet 518.

By contrast, when an interruption exists in the wireless connection 234 (507), the TCP data packet 522 from the session persistence driver 210 or Internet Protocol layer 208 (not shown) remains unacknowledged after some timed period, even after several retries (524, 526). As discussed above, this is a common occurrence on a wireless network, due to the high potential of a break in the wireless connection 234.

Accordingly, to prevent a TCP session termination which otherwise would be caused by the TCP layer 206 in the first device exceeding a predetermined number of retries, the session persistence driver 210 counts the number of retries for each TCP data packet. Upon exceeding a configurable number of retries (528) for a data packet (which is less than the predetermined number of retries required to terminate the TCP session), session persistence driver 210 sends a ZWA 214 to the TCP layer 206 in the first device. The ZWA 214 tells the sending TCP layer 206 in the first device to stop sending because the buffer window of the receiving TCP process is full, but to keep the connection/session open. The sending TCP layer 206 in the first device responds to the ZWA 214 by ceasing transmission and periodically testing the connection by transmitting a window advertisement probe 532. If the TCP layer in the server receives a window advertisement probe, the TCP connection may be reset. Session persistence driver 210, therefore, blocks the window advertisement probe 532 and continually transmits TCP keep-alive packets 534 to the session persistence driver 226 in the server 216. The transmission of TCP keep-alive packets 534 allows re-connection probing without the risk of resetting the TCP connection/session. TCP keep-alive packets are also valid TCP messages using standard TCP functionality, so using TCP keep-alive packets avoids the overhead of additional TCP connection management. Session persistence driver 210 also transmits a ZWA 214′ in response to each window advertisement probe to continue to placate the sending TCP layer 206 in the first device. Although re-connection using TCP keep-alive packets 534 is disclosed above, re-connection may be carried out by sending any message detectable by a peer session persistence driver.

Once communications are reestablished, the session persistence driver 226 in the server 216 will be able to respond to one of the continually-transmitted TCP keep-alive packets 534 by transmitting a TCP keep-alive ACK 538 back through the wireless network 235 to session persistence driver 210. TCP keep-alive ACK 538 informs session persistence driver 210 that the wireless connection 234 has been restored. Session persistence driver 210, upon receipt of keep-alive ACK 538, sends previous window announcement 540 to the TCP layer 206 in the first device, which tells the TCP layer 206 in the first device to continue re-transmitting the lost data taking into account the size of the buffer window as portrayed in the previous window announcement 540. The lost data is now retransmitted as TCP data packet 542, which, because communications are now restored, propagates as normal between the application 204 on the first device 202 and the server TCP layer 222 on the server 216 (resulting in TCP ACK 544) and, via byte stream 543, to the server application 218.

Having described the call diagram on the first device 202 side of the wireless connection, the TCP session persistence protocol works similarly to persist a TCP session on the mobility server 216/second device 236 side of the wireless connection 234. The network service 238 on the second device 236 and network applications 218 on the mobility server 216 transmit a byte-stream to their respective TCP layers, 240 and 222. The protocol stack on the second device 236 transmits data packets over the wired network 246 to the protocol stack on the server 216, which in turn transmits data packets over the wireless connection 235 to the protocol stack on the first device 202. Each transmitting TCP layer waits for a TCP ACK to acknowledge a successful transmission, as described above. Most aspects of TCP session persistence on the mobility server 216/second device 236 side of the wireless connection 234 are similar that of the first device side, and, therefore, will not be described in detail. Aspects of TCP session persistence on the server 216/second device 236 side upon the interruption of network communications, however, are described in detail directly below.

FIGS. 6A and 6B, therefore, show TCP session persistence upon an interruption in the wireless connection 234. FIGS. 6A and 6B show two responses by the session persistence driver 226 to the same detected interruption in communications. The TCP data packet 622 from the session persistence driver 210 remains unacknowledged after some timed period, even after several retries (624, 626).

FIG. 6A, illustrating TCP session persistence for the TCP session between the mobility server 216 and the first device 202, shows that the session persistence driver 226 counts the number of retries for each TCP data packet. Upon exceeding a configurable number of retries (628) for a data packet (which is less than the predetermined number of retries required to terminate the TCP session), session persistence driver 226 sends a ZWA 230 to the mobility server TCP layer 222. The ZWA 230 tells the sending mobility server TCP layer 222 to stop sending because the buffer window of the receiving TCP process is full, but to keep the connection/session open. The sending mobility server TCP layer 222 responds to the ZWA 230 by ceasing transmission and periodically testing the connection by transmitting a window advertisement probe 632.

Turning now to FIG. 6B, the session persistence driver 226 also sends a ZWA 232 to the TCP layer 240 in the second device through wired network 246. The ZWA 232 tells the sending TCP layer 240 at the second device to stop sending because the buffer window of the receiving TCP process is full, but to keep the connection/session open. The sending TCP layer 240 at the second device responds to the ZWA 232 by ceasing transmission and periodically testing the connection by transmitting a window advertisement probe 662. Ceasing transmission is important because the mobility server 216 cannot transmit, and continuing to transmit will overload the buffer in the proxy server 220, causing loss of data.

Returning to FIG. 6A, session persistence driver 226 receives the window advertisement probe 632 and continually transmits TCP keep-alive packets 634 to the session persistence driver 210 in the server 216. Session persistence driver 226 also transmits a ZWA 230′ in response to each window advertisement probe to continue to placate the sending TCP layer 222 in the mobility server.

Turning again to FIG. 6B, session persistence driver 226 receives the window advertisement probe 662. Session persistence driver 226 also transmits a ZWA 232′ in response to each window advertisement probe to continue to placate the sending TCP layer 240 in the second device.

Returning to FIG. 6A, once communications are re-established, the session persistence driver 210 in the server 216 will be able to respond to one of the continually-transmitted TCP keep-alive packets 634 by transmitting a TCP keep-alive ACK 638 back through the wireless network 235 to session persistence driver 226. TCP keep-alive ACK 638 informs session persistence driver 226 that the wireless connection 234 has been restored. Session persistence driver 226, upon receipt of keep-alive ACK 638, sends previous window announcement 640 to the TCP layer 222 in the server, which tells server TCP layer 222 to continue re-transmitting the lost data taking into account the size of the buffer window as portrayed in the previous window announcement 640. The previous window announcement is the window announcement declaring the buffer size at the time communications were lost. The lost data is now retransmitted as a TCP data packet, and normal communications resume.

Turning again to FIG. 6B, session persistence driver 226, upon receipt of keep-alive ACK 638, also sends previous window announcement 680 to the TCP layer 240 in the second device, which tells the TCP layer 240 in the second device to continue re-transmitting the lost data taking into account the size of the buffer window as portrayed in the previous window announcement 640. The second device resumes transmitting TCP packets, and normal communications resume.

It should be understood that the inventive concepts disclosed herein are capable of many modifications. To the extent such modifications fall within the scope of the appended claims and their equivalents, they are intended to be covered by this patent.

1. A first device capable of coupling to a network via a network communications stack running on the first device, the network communications stack includes a transport layer that allows network communications between the first device and a second device during a session, a method comprising:
monitoring, below the transport layer in the network communications stack, the network communications between the first device and the second device;
detecting a temporary interruption in the network communications; and
preventing the transport layer on the first device from terminating the session during the temporary interruption.

2. The method of claim 1 wherein the network communications are proxied by a server.

3. The method of claim 1 wherein the step of preventing comprises:
generating, below the transport layer in the network communications stack on the first device, a set of one or more signals adapted to be interpreted by the first device as coming from the second device; and
sending the set of one or more signals to the transport layer on the first device.

4. The method of claim 3 wherein the set of one or more signals indicates that a buffer allocated to receive incoming data at the second device is full.

5. The method of claim 1 wherein the transport layer having a transport protocol that is selected from a group consisting of: a transmission control protocol or a stream control transmission protocol.

6. The method of claim 1 wherein the network communications stack on the first device further includes a session persistence driver that operates below the transport layer in the network communications stack, and wherein the steps of monitoring and detecting are performed by the session persistence driver.

7. The method of claim 6 wherein the session persistence driver sends a signal to the transport layer on the first device to perform the step of preventing.

8. A server capable of coupling to a first device on a wireless network and coupling to a second device on a wired network, wherein the server, the first device and the second device each include a network communications stack that has a transport layer that allows network communications between the first device and the second device during a session, a method comprising:
monitoring, below the transport layer in the network communications stack on the server, the network communications between the first device and the second device over the wireless network;
detecting a temporary interruption in the network communications over the wireless network; and
preventing the transport layer on the second device from terminating the session during the temporary interruption.

9. The method of claim 8 wherein the step of preventing comprises:
generating, below the transport layer in the network communications stack on the server, a set of one or more signals adapted to be interpreted by the second device as coming from the first device; and
transmitting the set of one or more signals to the second device over the wired network to prevent the transport layer on the second device from terminating the session during the temporary interruption.

10. The method of claim 8 wherein the set of one or more signals indicates that a buffer allocated to receive incoming data at the first device is full.

11. The method of claim 8 wherein the transport layer having a transport protocol that is selected from a group consisting of: a transmission control protocol or a stream control transmission protocol.

12. The method of claim 8 wherein the network communications stack on the server further includes a session persistence driver that operates below the transport layer in the network communications stack on the server, and wherein the steps of monitoring, detecting and preventing are performed by the session persistence driver on the server.

13. A server capable of coupling to a first device on a wireless network during a first session and coupling to a second device on a wired network during a second session, wherein the server, the first device and the second device each include a network communications stack that has a transport layer that allows network communications between the first device and the second device, a method comprising:
monitoring, below the transport layer in the network communications stack on the server, the network communications between the first device and the second device during the first session;
detecting a temporary interruption in the network communications during the first session;
preventing the transport layer on the server from terminating the first session during the temporary interruption; and
preventing the transport layer on the second device from terminating the second session during the temporary interruption.

14. The method of claim 13 wherein the first session is transparent to the second device and the second session is transparent to the first device.

15. The method of claim 13 wherein the step of preventing the transport layer on the server from terminating the first session during the temporary interruption comprises:
generating, below the transport layer on the server, a set of one or more signals adapted to be interpreted by the server as coming from the first device; and
sending the set of one or more signals to the transport layer on the server.

16. The method of claim 15 wherein the set of one or more signals indicates that a buffer allocated to receive incoming data at the first device is full.

17. The method of claim 13 wherein the step of preventing the transport layer on the second device from terminating the second session during the temporary interruption comprises:
generating, below the transport layer on the server, a set of one or more signals adapted to be interpreted by the second device as coming from the first device; and
transmitting the set of one or more signals to the second device over the wired network to prevent the transport layer on the second device from terminating the second session during the temporary interruption.

18. The method of claim 17 wherein the set of one or more signals indicates that a buffer allocated to receive incoming data at the first device is full.

19. The method of claim 13 wherein the transport layer having a transport protocol that is selected from a group consisting of: a transmission control protocol or a stream control transmission protocol.

20. The method of claim 13 wherein the network communications stack on the server further includes a session persistence driver that operates below the transport layer, and wherein the steps of monitoring, detecting, preventing, and preventing are performed by the session persistence driver on the server.

21. The method of claim 13 further comprising preventing the transport layer on the server from terminating the second session during the temporary interruption.
